(19) United States
(12) Patent Application Publication
(10) Pub. No.: US 2020/0191184 A1
(43) Pub. Date: Jun. 18, 2020

(54) SPACING DEVICE WITH ANGULAR ADJUSTMENT

(71) Applicant: A. RAYMOND ET CIE, Grenoble (FR)

(72) Inventor: David Lamoureux, Grenoble (FR)

(21) Appl. No.: 16/472,814

(22) PCT Filed: Dec. 22, 2017
(86) PCT No.: PCT/FR2017/053838

§ 371 Date: Jun. 21, 2019

(30) Foreign Application Priority Data
Dec. 23, 2016 (FR) 1663342

(51) Int. Cl. F16B 5/02

(52) U.S. Cl. CPC F16B 5/0233

(57) ABSTRACT

A spacing device with angular adjustment for filling the space separating a first support from a second support arranged facing the first support includes an attachment part, a spacing part, a drive ring, and a support ring. The attachment part is intended to be rigidly connected to the first support. The spacing part has a spherical tipped support end. The drive ring include an attachment system and is housed in the spacing part and coupled to the spacing part. The attachment part and the spacing part are assembled together, and the support ring is held against the spacing part and retained by the attachment device of the drive ring. The support ring has a face with a spherical cap.

### CROSS-REFERENCE TO RELATED APPLICATIONS

This application is a national phase entry under 35 U.S.C. § 371 of International Patent Application PCT/FR2017/053838, filed Dec. 22, 2017, designating the United States of America and published as International Patent Publication WO 2018/115799 A1 on Jun. 28, 2018, which claims the benefit under Article 8 of the Patent Cooperation Treaty to French Patent Application Serial No. 1663342, filed Dec. 23, 2016.

### TECHNICAL FIELD

This disclosure relates to a spacing device that can be placed between two supports in such a way as to bridge the distance between them. The disclosure has a particular application in the automotive field, to fill the space between a load-bearing element and a roof body of a vehicle and to allow, for example, the fixing of roof bars on this vehicle.

### BACKGROUND

A spacing device designed to fill a space between sheet metal elements that make up the structure of a vehicle and to compensate for any dimensional differences that may exist between these elements is known from Document EP2532568. This known spacing device comprises an attachment part intended to be supported on and/or attached to a first support and a spacing part having a support end intended to come into contact with a second support, placed opposite the first one. The attachment part and the spacing part are assembled together at threads that allow them to be moved relative to each other in an axial direction, to allow the spacing device to be adjusted to the distance between the two supports.

In this quoted document, the spacing device is attached to a roof bar placed on the outside of the first support by means of a through screw. A bolt and washer system on the outside of the second support makes it possible to lock the spacing device and to rigidly connect the roof bar to the first support.

The spacing device is driven in rotation by the attachment screw of the roof bar. The adjustment to the distance between the two supports and the attachment of the roof bar (or more generally the locking of the spacing device) are carried out simultaneously. If these two functions are not perfectly coordinated, it is possible that the locking will occur before the spacing part is perfectly in place, which can lead to deformation of either support.

In addition, the presence of the roof bar on the first support side requires working on the second support side, inside the vehicle, to adjust the spacing device. The small and confined space contributes to making the installation of the spacing device difficult.

Finally, when the first and second supports have an angular offset, i.e., when the faces facing the supports are not perfectly parallel to each other, the contact between the spacing device and the second support is not perfect. In this case, locking the spacing device using the attachment screw can lead to deformation of either support.

Other forms of spacing devices are known from EP2130722, DE10201000000134, DE202011100696 or document “Kugel-Ausgleichs-Scheibe Kas”, Antriebstechnik, Vereinigte Fachverlage, Mainz, DE, Vol 33, n 11, Jan. 11, 2014.

This disclosure is intended to compensate for all or part of the above-mentioned disadvantages.

### BRIEF SUMMARY

In order to achieve this goal, the object of the disclosure proposes a spacing device with an angular adjustment to fill the space between a first support and a second support disposed opposite the first support, the spacing device comprising:
an attachment part intended to be rigidly connected to the first support and having an internal thread;
a spacing part with an external thread and a spherical tipped support end;
a drive ring comprising a hooking system, the drive ring being housed in the spacing part and coupled to this part;
the attachment part and the spacing part being assembled together at their respective threads and being movable relative to each other in an axial direction to adjust the spacing device to the distance between the two supports.
The spacing device comprises a support ring held against the spacing part and retained by the drive ring hooking device, the support ring having a first flat face to bear on the second support, and a second spherical cap face receiving the spherical tipped end of the spacing part.
According to other advantageous and unrestrictive characteristics of the disclosure, taken alone or in any technically feasible combination:
the drive ring is provided with at least one boss or at least one recess to facilitate the application of a torque by a tool;
the hooking system and the support ring have sufficient operating clearance to allow movement of the support ring;
the hooking system is formed by at least one notch to receive an internal shoulder of the support ring;
the notch is defined by an external shoulder and a retaining flange supported by a flexible lug;
the external shoulder is carried by the flexible lug;
the attachment part includes a support body and a retaining member to rigidly connect the device to the first support.

### BRIEF DESCRIPTION OF THE DRAWINGS

Other characteristics and advantages of the disclosure will emerge from the detailed description of the disclosure that follows with reference to the appended figures on which:

the FIGS. 1a and 1b respectively show an exploded view and a cross-section of a spacing device according to a first embodiment according to the disclosure;

FIGS. 2a to 2d show the different steps in the implementation of a particular example of the spacing device of the disclosure;

FIG. 3 shows an exploded view of a spacing device according to a second embodiment according to the disclosure.

### DETAILED DESCRIPTION

A spacing device according to the disclosure is intended to fill the space between a first support and a second support, arranged opposite each other. The term “internal face” refers to the faces of the first and second supports that are placed opposite each other; and the term “external face” refers to the faces of the first and second supports opposite these internal faces. The distance between the first and second supports is not precisely known, and the device of the disclosure makes it possible to compensate for these differences that may exist from one point to another of the supports. As such, several spacing devices can be placed between the supports in order to more precisely control the distance separating them over their entire length.

Usually, these supports are flat, at least in the vicinity of the position where the spacing device is installed. The two supports may have an angular offset and may not be perfectly parallel to each other, and this disclosure is designed specifically to compensate for this angular offset.

The first and second supports each have an opening facing each other, allowing the spacing device to be placed between the two supports and allowing the passage of a locking element retained on the side of each external face of the supports. The spacing device may also have the function of allowing a complementary element to be rigidly connected to the external surface of one or the other of the supports. In this case, the locking element, such as a through screw, also allows the complementary element to be firmly pressed against the external face of one of the supports.

FIGS. 1a and 1b respectively show an exploded view and a cross-section of a spacing device 1 according to a first embodiment according to the disclosure.

The spacing device 1 comprises an attachment part 2 including an internal thread or tapping 2c. The attachment part 2 is intended to be attached to the first support. For this purpose, it may comprise a retaining member 2a and a supporting body 2b. The spacing device 1 can be inserted and positioned in the space between the two supports through an opening provided beforehand in the first support. The retaining member 2a may include one or more flexible lug(s) 4e that contract(s) when the spacing device is inserted into the opening to abut the external face of the first support on the support body 2b, and retract(s) to lock this position. The attachment part 2 may also have a non-circular external section to block its rotation relative to the support when installed on the first support, as clearly shown in FIG. 1a.

The spacing device 1 according to the disclosure also includes a spacing part 3 with an external thread 3c. The spacing part 3 and the attachment part 2 are designed to be assembled to each other at their respective threads 3c, 2c. The rotational drive of spacing part 3 allows the two parts to be moved relative to each other in an axial direction.

A spacing part 3 has a cylinder shape, the thread being formed on the external surface of this cylinder, so that it can be screwed and unscrewed onto/from the attachment part 2.

A spacing part 3 has two ends, a first drive end 3a oriented toward the attachment part 2 side, and a support end 3b opposite the drive end 3a. The bearing end 3b has a spherical tip.

The spacing device also includes a support ring 5 held against the spacing part, on the side of its support end 3b, and having a first flat face to bear on the second support, and a second spherical capped face to receive the spherical tipped support end 3b of the spacing part 3.

When the spacing device 1 is placed in the space between the two supports, the flat face of the ring 5 bears on the second support to maintain the distance between the two supports even when efforts try to bring them closer together. The spherical tipped end 3b of the spacing device 3 cooperates with the spherical cap of the support ring 5 to form a ball, allowing the support ring 5 to tilt and bring its first flat face into planar contact with the second support, even though the latter has an angular offset with the first support.

To enable this support socket to be adjusted, the device 1, according to the disclosure, is advantageously provided with a drive ring 4. The drive ring 4 is designed to be accommodated in the spacing part 3, for example, inside the cylinder. The drive ring 4 can itself be shaped like a hollow cylinder, the external diameter of which substantially corresponds to the internal diameter of the cylinder forming the spacing part 3, so that it can be inserted therein. The drive ring 4 and the spacing part 3 are so combined that an axial rotation torque applied to the drive ring 4 is transmitted to the spacing part 3. This coupling can be carried out by any means known per se, for example, by giving the internal cylinder of the spacing part 3 and the external cylinder of the drive ring 4 a non-circular cross-section preventing the axial rotation of one part relative to the other.

The drive ring 4 advantageously has at least one recess or a boss that allows a drive torque to be applied to the ring 4 by means of a suitable tool in order to move it in rotation. The recess or the boss can be formed on the inner wall of the ring 4. A plurality of such recesses or bosses can be arranged to form a slot, a star, a square in the drive ring 4 to facilitate cooperation with the end of a tool, such as a screwdriver, and its rotational drive.

The drive ring 4 allows the spacing part 3 to be rotated when it is itself rotated by a tool. The spacing part 3 can thus be screwed and/or unscrewed into/from the attachment part 2, and the axial displacement of the spacing part 3 can be adjusted to bring the support ring 5 into contact with the second support.

To hold the support ring 5 against or near the spacing part 3, the drive ring 4 is provided with a hooking system 4a cooperating with an internal shoulder 5a of the support ring 5 to rigidly connect same to each other.

The hooking system 4a can include an external shoulder 4b on the side of the end of the drive ring 4 facing the support ring 5 and at least one flexible lug 4e carrying a retaining flange 4c on its surface. The retaining flange 4c and the external shoulder 4b define a notch 4d making it possible to clip the internal shoulder 5a of the support ring 5 onto the drive ring 4. The notch 4d and the shoulder 5a have sufficient operating clearance between them to allow small amplitude movements of the support ring 5 relative to the drive ring.

Preferably, the hooking system 4a includes a plurality of flexible lugs 4e, defining as many notches 4d distributed over the periphery of the end of the drive ring 4. The operating clearance is in this case present at each notch 4d and distributed all around the spherical cap.

In the first embodiment of FIG. 1A, the drive ring 4 is provided with four lugs 4e defined by four through slots. In this embodiment, the retaining flange 4c and the external shoulder 4b are carried by each flexible lug 4e.

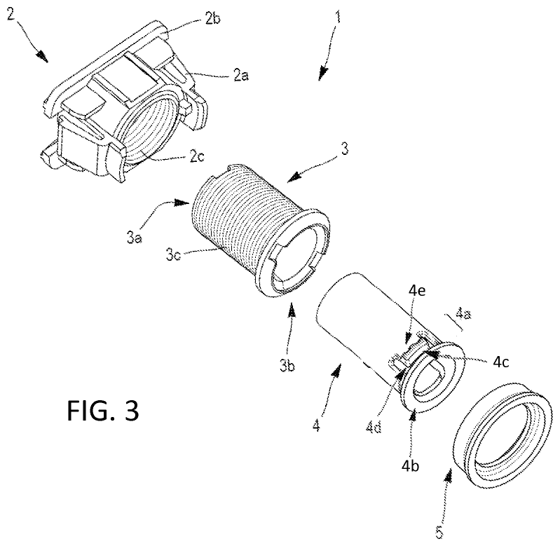

FIG. 3 shows a second embodiment of the spacing device, wherein the slots defining the lugs 4e of the hooking system 4a do not lead to the end of the drive ring 4. In this embodiment, only the retaining flange 4c is carried by a flexible lug 4e. The external shoulder 4b is rigidly connected to the rest of the drive ring 4. In this embodiment, to clip the support ring 5 onto the hooking system 4a, this ring 5 is slid along the drive ring 4, after having been inserted from the end opposite the one carrying the hooking system 4a.

Regardless of the embodiment chosen for the hooking system 4a, the support end 3b of the spacing part 3 may include a recess, the dimensions of which are sufficient to accommodate the retaining flange 4c. Thus, the support ring 5 can be held against the spacing part 3, the spherical cap of the support ring 5 receiving the spherical tipped end 3b of the spacing part 3 to form a ball joint.

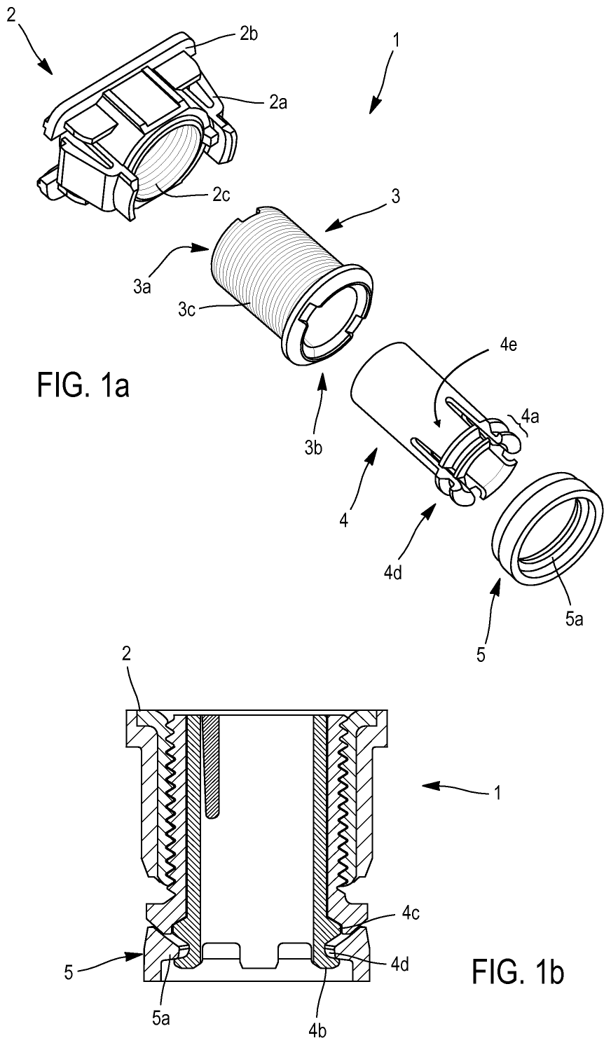

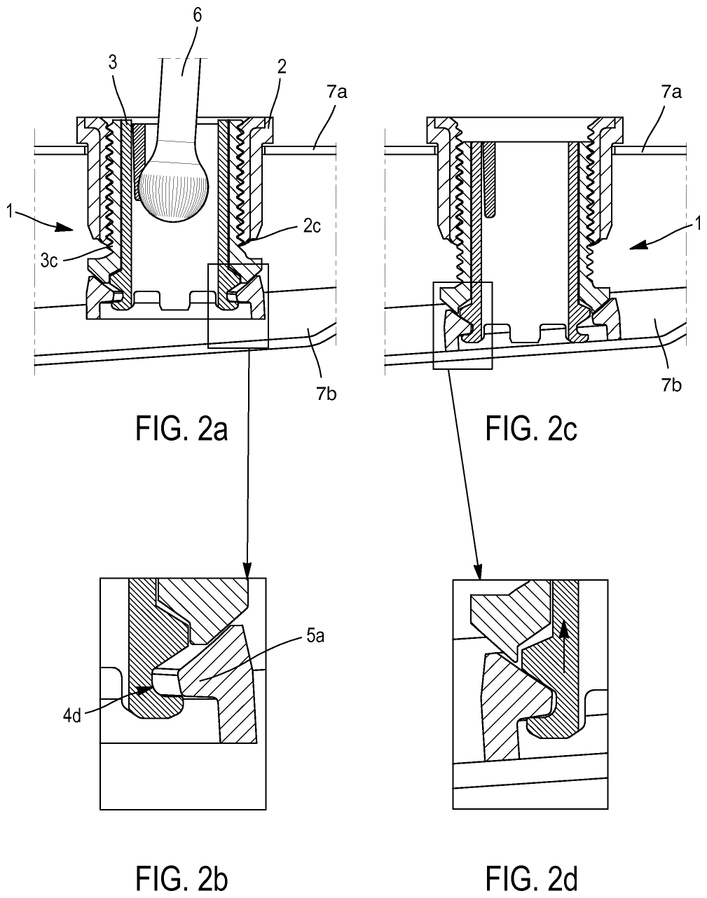

This advantageous configuration can be used to compensate for an angular offset between two supports when installing the spacing device 1, as described in detail in FIGS. 2a to 2d. FIG. 2a represents a cross-sectional view of a device 1 according to the disclosure attached to a first support 7a. A tool 6 is positioned on the attachment part 2 side, i.e., on the external face side of the first support 7a that the device 1 is attached to. The tool 6 has a head cooperating with bosses or recesses formed on the internal face of the drive ring 4.

The rotational movement of the tool 6 on itself, possibly supplemented by its inclination, causes the ring 4 and the spacing part 3 coupled thereto to rotate.

The threads 2c, 3c provided on the attachment 2 and spacing parts 3 make it possible to axially move the spacing part 2 until a portion of the flat face of the support ring 5 comes into contact with the second support 7b. This support 7b has an angular offset, which can be several degrees, with the first support 7a.

FIG. 2b shows an enlarged view of the hooking system 4a of the drive ring 4 cooperating with the shoulder 5a of the support ring 5, before this contact occurs. The clearance between the notch 4d and the internal shoulder 5a that rests in this notch can be observed.

The maintained rotational movement of the tool 6 continues to cause the axial displacement of the spacing part 3, to place the spacing device 1 in a final configuration shown in FIG. 2c.

In this configuration, the flat face of the support ring 5 ensures a planar contact with the second support 7b. The inclination of the support ring 5 is made possible by the ball joint formed between this support ring 5 and the spherical tipped end 3a of the spacing part 3. It is also made possible by the operating clearance in the hooking system 4a.

FIG. 2d shows an enlarged view of the hooking system 4a of the drive ring cooperating with the shoulder 5a of the support ring 5, after the planar contact has been made. It can be seen that the clearance is distributed in a differentiated way in the notches 4d forming the hooking system, so as to allow the rotation of the support ring 5.

When the spacing device 1 is also used as an attachment support for a complementary element, the installation and adjustment of the spacing device 1 are carried out before positioning the complementary element, for example, on the external face of the first support 7a, at the attachment part 2. The tool 6 can therefore be inserted on this side of the support for positioning the device 1, then the possible complementary element can be fixed on the attachment part 2 during a final assembly step, for example, by inserting a through attachment screw, introduced on the side of the external face of the second support 7b, the complementary element then forming a nut.

The disclosure has a very specific application in the field of automobiles, to rigidly connect a bar, forming the complementary element, on the roof of a vehicle.

For reasons of ease of manufacture and cost, the device 1 is advantageously made of plastic material, obtained by moulding or extrusion. But it could be made of another material or obtained by another manufacturing process, for example, by additive manufacturing.

Of course, the disclosure is not limited to the mode of implementation described and alternative embodiments can be provided without going beyond the scope of the invention as defined by the claims.

1.-7. (canceled)

8. A spacing device with angular adjustment for filling the space separating a first support from a second support that is separated from the first support by a distance, the spacing device comprising:
an attachment part configured to be rigidly connected to the first support and having an internal thread;
a spacing part having an external thread and a support end having a rounded tip;
a drive ring comprising a latching device, the drive ring being housed in the spacing part and coupled to the spacing part;
the attachment part and the spacing part being assembled together at their respective threads and being movable relative to each other in an axial direction to adjust the spacing device to the distance separating the first support and the second support, the spacing device comprising a support ring held against the spacing part and retained by the latching device of the drive ring, the support ring having a first flat face for bearing against the second support, and a second rounded face for bearing against the rounded tip of the spacing part.

9. The spacing device of claim 8, wherein the drive ring comprises at least one boss or at least one recess configured to enable application of a torque to the drive ring by a tool.

10. The spacing device of claim 9, wherein the latching device and the support ring have a sufficient operating clearance to allow movement of the support ring.

11. The spacing device of claim 10, wherein the latching device comprises at least one notch configured to receive an internal shoulder of the support ring.

12. The spacing device of claim 11, wherein the at least one notch is defined by an external shoulder and a retaining flange carried by a flexible lug.

13. The spacing device of claim 12, wherein the attachment part has a non-circular external section.

14. The spacing device of claim 13, wherein the attachment part comprises a support body and a retaining member configured to enable the spacing device to be rigidly connected to the first support.

15. The spacing device of claim 8, wherein the latching device and the support ring have a sufficient operating clearance to allow movement of the support ring.

16. The spacing device of claim 8, wherein the latching device comprises at least one notch configured to receive an internal shoulder of the support ring.

17. The spacing device of claim 16, wherein the at least one notch is defined by an external shoulder and a retaining flange carried by a flexible lug.

18. The spacing device of claim 8, wherein the attachment part has a non-circular external section.

19. The spacing device of claim 8, wherein the attachment part comprises a support body and a retaining member configured to enable the spacing device to be rigidly connected to the first support.
